(19) United States
(12) Patent Application Publication
(10) Pub. No.: US 2022/0338449 A1
(43) Pub. Date: Oct. 27, 2022

(54) Bird Feeder

(71) Applicants: Josephine Coleman-Williams, MIdway, GA (US); James T. Coleman, SR., (US)

(72) Inventors: Josephine Coleman-Williams, MIdway, GA (US); James T. Coleman, SR., (US)

(21) Appl. No.: 17/730,084

(22) Filed: Apr. 26, 2022

Related U.S. Application Data
(60) Provisional application No. 63/179,576, filed on Apr. 26, 2021.

(51) Int. Cl. A01K 39/014

(52) U.S. Cl. CPC A01K 39/014

(57) ABSTRACT

Certain exemplary embodiments can provide a tray and a bar. The tray defines a cavity. The tray has a rectangular cross section. The tray comprises a bottom. The bottom is surrounded by a lip. The bottom and the lip form a rectangular bowl. The bowl is constructed to retain bird feed. The tray has an open top. The bar is coupled to the bottom of the tray.

### CROSS-REFERENCES TO RELATED APPLICATIONS

This application claims priority to, and incorporates by reference herein in its entirety, pending U.S. Provisional Patent Application Ser. No. 63/179,576 (Attorney Docket No. 1521-02), filed Apr. 26, 2021.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is an end view of a portion of an exemplary embodiment of a bird feeder 1000;

FIG. 2 is a plan view of exemplary bird feeder 1000;

FIG. 3 is an end view of exemplary bird feeder 1000;

FIG. 4 is a perspective view of exemplary bird feeder 1000;

FIG. 5 is a side view of exemplary bird feeder 1000;

FIG. 6 is a side view of exemplary bird feeder 1000; and

FIG. 7 is a plan view of exemplary bird feeder 1000.

### DETAILED DESCRIPTION

Certain exemplary embodiments can provide a tray and a bar. The tray defines a cavity. The tray has a rectangular cross section. The tray comprises a bottom. The bottom is surrounded by a lip. The bottom and the lip form a rectangular bowl. The bowl is constructed to retain bird feed. The tray has an open top. The bar is coupled to the bottom of the tray.

Certain exemplary embodiments can be called the “Bird Buddy Landing Zone” (“BBLZ”), which is an open style bird feeder constructed to feed a variety of birds. The BBLZ can also provide an observer with a clear vision of nature's interplay through birdwatching. The BBLZ can also provide an observer with a full view of various birds feeding and interacting together at a distance that would allow birds to feel safe and remain at the bird feeder rather than to flee due to fright. The BBLZ can be visually pleasing to the bird watcher without the confines of certain bird houses or hanging tubular feeders that can block the observer's view of birds situated on an opposing side of the bird houses or hanging tubular feeders. Certain exemplary embodiments can be set up by securing a post component at ground level, or to any railing system affixed to a patio deck or balcony via hardware fasteners, that can allow an upper tray of the bird feeder to be rotated inward for seed filling and return to an outer position.

The BBLZ comprises a vertical tubular post, an upper connective sleeve component to redirect a second shorter section of tubing at approximately 90 degrees or in a horizontal direction to support the tree like birdfeeder/play area. The tubular pole system feeding tray and connector can be made of a metal such as stainless steel or steel with a protective powder coated paint color finish as a rust and corrosion preventative.

The tray can have upper turned edges to aid in containing supplied birdseed while a flat tray surface creates a feeding/play area. The tray surface can be a pattern series of through holes to serve as a water drainage system for rain egress. The overall size, shape, all parts in componentry sizes shapes configurations material composition, dimensions, and bird feeding-interface applications can be developed during the design and engineering phases prior to manufacture.

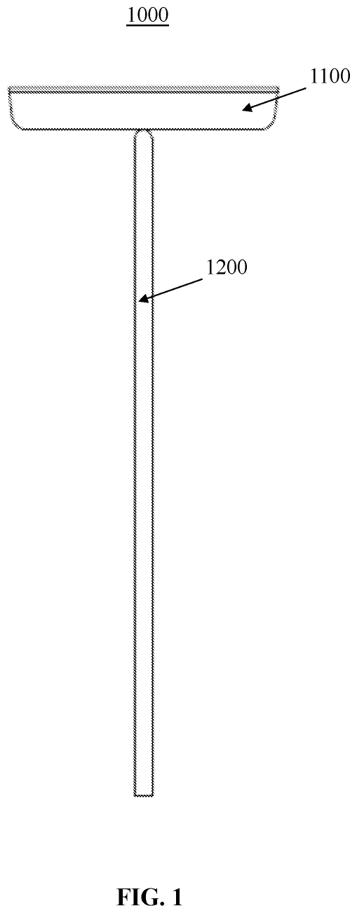

FIG. 1 is an end view of a portion of an exemplary embodiment of a bird feeder 1000, which comprises a tray 1100 and a bar 1200.

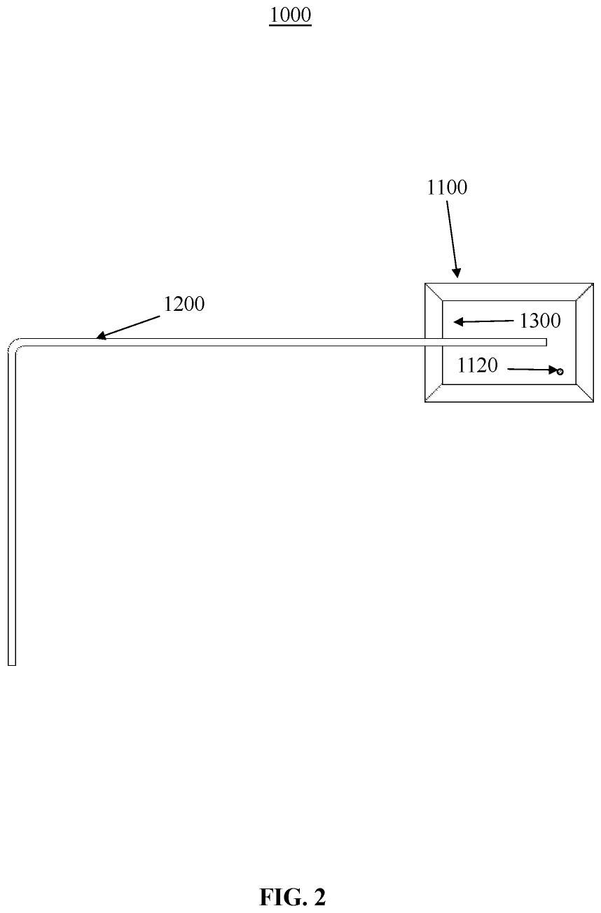

FIG. 2 is a plan view of exemplary bird feeder 1000, which comprises tray 1100 and bar 1200. Tray 1100 defines a cavity 1300. Tray 1100 has a rectangular cross-section.

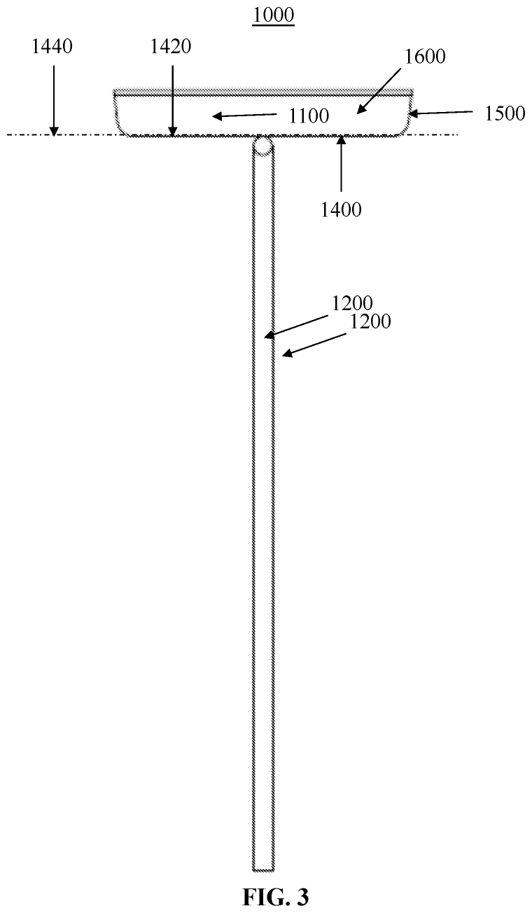

FIG. 3 is an end view of exemplary bird feeder 1000, which comprises tray 1100 and bar 1200. Tray 1100 comprises a bottom 1400. Bottom 1400 is surrounded by a lip 1500. Bottom 1400 and lip 1500 form a bowl 1600. Bowl 1600 is constructed to retain bird feed. Bottom 1400 of tray 1100 can define at least one aperture 1120 (see aperture 1120 of FIG. 2). At least one aperture 1120 constructed to drain liquid from tray 1100.

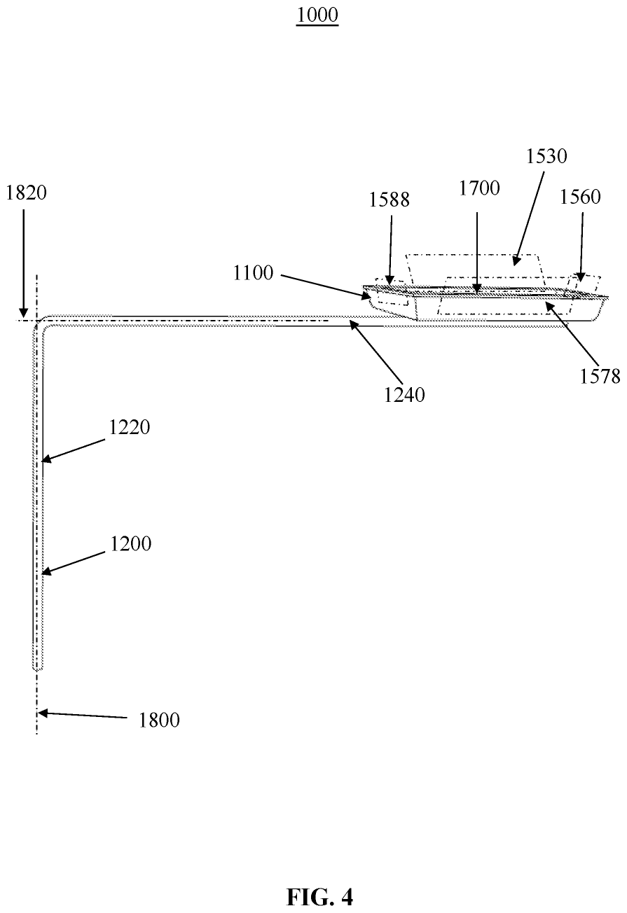

FIG. 4 is a perspective view of exemplary bird feeder 1000, which comprises tray 1100 and bar 1200. Tray 1100 has an open top 1700. Bar 1200 is coupled to bottom 1400 of tray 1100. Bar 1200 comprises a first portion 1220 and a second portion 1240. Wherein a first longitudinal axis 1800 of first portion 1220 is substantially perpendicular to a second longitudinal axis 1820 of the second portion 1240.

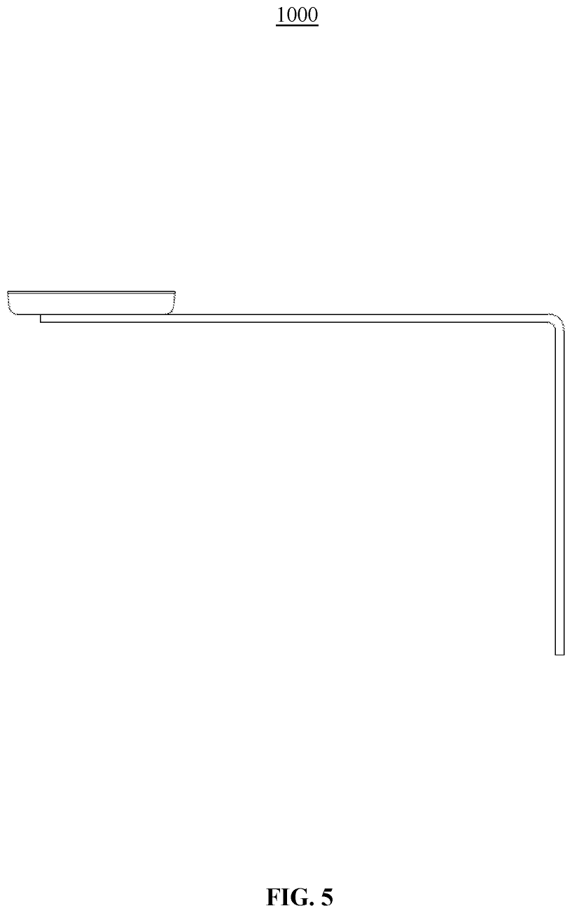

FIG. 5 is a side view of exemplary bird feeder 1000.

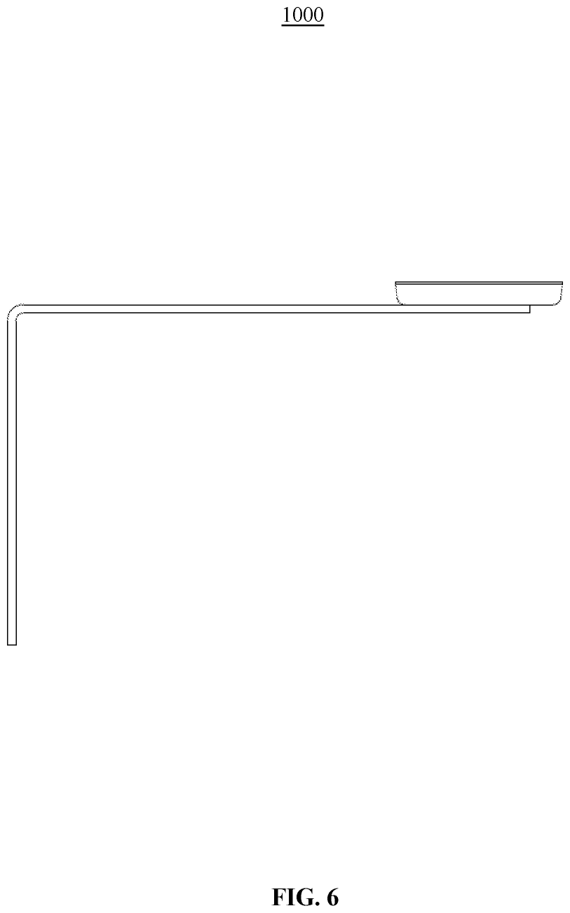

FIG. 6 is a side view of exemplary bird feeder 1000.

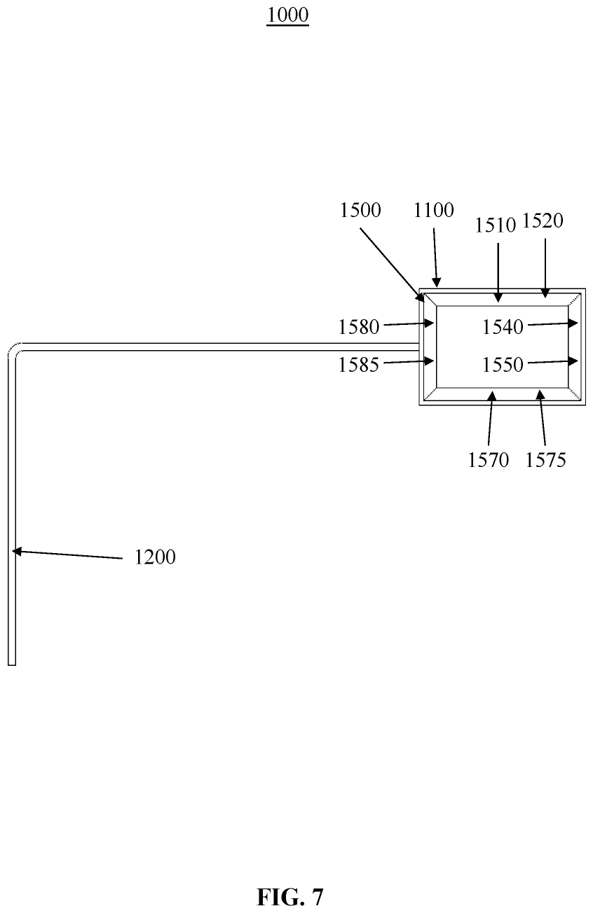

FIG. 7 is a plan view of exemplary bird feeder 1000, which comprises tray 1100 and bar 1200. Lip 1500 comprises:
a first side 1510, first side 1510 having a first face 1520 that defines a first plane 1530 (see first plane 1530 of FIG. 4);
a second side 1540, second side 1540 having a second face 1550 that defines a second plane 1560 (see second plane 1560 of FIG. 4);
a third side 1570, third side 1570 having a third face 1575 that defines a third plane 1578 (see third plane 1578 of FIG. 4); and
a fourth side 1580, the fourth side 1580 having a fourth face 1585 that defines a fourth plane 1588 (see fourth plane 1588 of FIG. 4); and
a surface 1420 of bottom 1400 of tray 1100 defines bottom plane 1440 (see surface 1420 and bottom plane 1440 FIG. 3); and
bottom plane 1440 intersects with each of the first plane 1530, second plane 1560, third plane 1578, and fourth plane 1588 at obtuse angles (see FIG. 4).

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.

a—at least one.

activity—an action, act, step, and/or process or portion thereof

adapter—a device used to effect operative compatibility between different parts of one or more pieces of an apparatus or system.

and/or—either in conjunction with or in alternative to.

apparatus—an appliance or device for a particular purpose.

aperture—an opening in something.

associate—to join, connect together, and/or relate.

bar—a length of material.

bird—any of a class of warm-blooded vertebrates distinguished by having the body more or less completely covered with feathers and the forelimbs modified as wings.

bird feeder—a container constructed to hold substances consumable by birds.

bottom—a lowermost portion of something when oriented in an installed position.

bowl—a vessel having a concave portion that can retain substances.

can—is capable of, in at least some embodiments.

cavity—a hollow space in an object.

comprising—including but not limited to.

configure—to make suitable or fit for a specific use or situation.

connect—to join or fasten together.

constructed to—made to and/or designed to.

convert—to transform, adapt, and/or change.

couple—to physically join in some fashion.

coupleable—capable of being joined, connected, and/or linked together.

cross-section—a section formed by a plane cutting through an object, such as at right angles to an axis.

define—to establish the outline, form, or structure of.

determine—to obtain, calculate, decide, deduce, and/or ascertain.

device—a machine, manufacture, and/or collection thereof

drain—to remove a substance via a flow.

feed—(n) consumable substances (v) to supply consumable substances.

form—to create.

install—to connect or set in position and prepare for use.

intersect—to pierce by passing through or across.

lip—a projecting portion of an object.

liquid—a fluid (as water) that has no independent shape but has a definite volume and does not expand indefinitely and that is only slightly compressible.

longitudinal axis—a straight line defined parallel to an object's length and passing through a centroid of the object.

may—is allowed and/or permitted to, in at least some embodiments.

method—a process, procedure, and/or collection of related activities for accomplishing something.

obtuse angle—an angle larger than a right angle and smaller than a straight angle (i.e., between 90° and 180°).

open—allowing access to inside.

perpendicular—meeting at substantially right angles.

plane—a substantially flat, two-dimensional surface.

plurality—the state of being plural and/or more than one.

portion—a part of a whole.

predetermined—established in advance.

provide—to furnish, supply, give, and/or make available.

receive—to get, take, acquire, and/or obtain.

rectangular—a geometric shape defined by a plurality of substantially right angles.

repeatedly—again and again; repetitively.

request—to express a desire for and/or ask for.

retain—hold in a manner that resists motion.

set—a related plurality.

side—a bounding surface of an object.

store—to place, hold, and/or retain.

substantially—to a great extent or degree.

support—to bear the weight of, especially from below.

surface—the outer boundary of an object or a material layer.

surround—to enclose on at least four sides

system—a collection of mechanisms, devices, machines, articles of manufacture, processes, data, and/or instructions, the collection designed to perform one or more specific functions.

top—an uppermost portion of something when oriented in an installed position.

transmit—to send, provide, furnish, and/or supply.

tray—an open receptacle with a flat bottom and a rim that can hold bird feed.

via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:

there is no requirement for the inclusion of any particular described or illustrated characteristic, function, activity, or element, any particular sequence of activities, or any particular interrelationship of elements;

no characteristic, function, activity, or element is “essential”;

any elements can be integrated, segregated, and/or duplicated;

any activity can be repeated, any activity can be performed by multiple entities, and/or any activity can be performed in multiple jurisdictions; and

any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a tray, the tray defining a cavity, the tray having a rectangular cross-section, the tray comprising a bottom, the bottom surrounded by a lip, the bottom and the lip forming a bowl, the bowl constructed to retain bird feed, the tray having an open top; and
a bar, the bar coupled to the bottom of the tray, the bar comprising a first portion and a second portion, wherein a first longitudinal axis of the first portion is substantially perpendicular to a second longitudinal axis of the second portion.

2. The system of claim 1, wherein:
the bottom of the tray has at least one aperture, the at least one aperture constructed to drain liquid from the tray.

3. The system of claim 1, wherein:
the lip comprises:
a first side, the first side having a first face that defines a first plane;
a second side, the second side having a second face that defines a second plane;
a third side, the third side having a third face that defines a third plane; and
a fourth side, the fourth side having a fourth face that defines a fourth plane;
a surface of the bottom of the tray defines a bottom plane; and
the bottom plane intersects with each of the first plane, the second plane, the third plane, and the fourth plane at obtuse angles.
